(19) United States
(12) Patent Application Publication
(10) Pub. No.: US 2022/0405147 A1
(43) Pub. Date: Dec. 22, 2022

(54) TASK PROCESSING METHOD, ELECTRONIC DEVICE AND STORAGE MEDIUM

(71) Applicant: BEIJING DAJIA INTERNET INFORMATION TECHNOLOGY CO., LTD., Beijing (CN)

(72) Inventors: Minjie XIE, Beijing (CN); Yuan WANG, Beijing (CN); Jing LI, Beijing (CN); Shu ZHANG, Beijing (CN)

(21) Appl. No.: 17/843,663

(22) Filed: Jun. 17, 2022

(30) Foreign Application Priority Data
Jun. 21, 2021 (CN) 202110688135.1

(51) Int. Cl. G06F 9/50

(52) U.S. Cl. CPC G06F 9/5077

(57) ABSTRACT

The present disclosure relates to a task processing method, electronic device and storage medium. The method includes: the client displaying first task information for a first task and second task information for a second task, where a first subtask in the first task corresponds to same event information as a second subtask in the second task, the first task information includes a first task progress parameter, and the second task information includes a second task progress parameter; and updating, in response to a received event processing command having pending event information that matches the first subtask or the second subtask, the first task progress parameter and the second task progress parameter based on the pending event information.

### CROSS-REFERENCE TO RELATED APPLICATION

The present disclosure claims priority to Chinese Patent Application No. 202110688135.1, titled “TASK PROCESSING METHOD, ELECTRONIC DEVICE AND STORAGE MEDIUM,” filed on Jun. 21, 2021, in the China National Intellectual Property Administration, the content of which is incorporated herein by reference in its entirety.

### TECHNICAL FIELD

The present disclosure relates to the field of Internet technology and, in particular, to task processing methods.

### BACKGROUND

With the current rapid development of mobile Internet, mobile terminal-based task processing has become increasingly more mature. Usually there is only one task in a framework, or a task is triggered by only a single condition, which makes users feel monotonous and dull when completing tasks on mobile terminals, and affects user experience over time.

### SUMMARY

The present disclosure relate to task processing methods. The technical solutions of the present disclosure are as follows.

According to some arrangements of the present disclosure, a task processing method includes displaying, by a client, first task information for a first task and second task information for a second task in an application, where a first subtask in the first task corresponds to same event information as a second subtask in the second task, the first task information includes a first task progress parameter, and the second task information includes a second task progress parameter, and updating, by the client, in response to a received event processing command having pending event information that matches the first subtask or the second subtask, the first task progress parameter and the second task progress parameter based on the pending event information.

According to some arrangements of the present disclosure, an electronic device includes a processor, and a memory for storing instructions executable by the processor, where the processor is configured to execute the instructions to implement one of the methods as described herein.

According to some arrangements of the present disclosure, a non-transitory computer-readable storage medium stores computer-readable instructions, such that, when executed by the processor of the electronic device, enables the electronic device to perform one of the methods described herein.

According to some arrangements of the present disclosure, a computer program product including a computer program stored in the readable storage media. At least one processor of the computer device reads and executes the computer program from the readable storage medium, causing the computer device to perform one of the methods described herein.

It should be understood that the foregoing general description and the following detailed description are examples and explanatory only and do not limit the present disclosure.

### BRIEF DESCRIPTION OF THE DRAWINGS

The accompanying drawings, incorporated into and form part of the specification, illustrate arrangements consistent with the present disclosure, and are used in conjunction with the specification to explain the principles of the present disclosure and do not constitute an undue limitation of the present disclosure.

FIG. 1 is a schematic diagram of an application environment illustrated in accordance with an example arrangement.

FIG. 2 is a flow chart of a task processing method illustrated in accordance with an example arrangement.

FIG. 3 is a schematic diagram of displaying a task page illustrated in accordance with an example arrangement.

FIG. 4 is a schematic diagram of displaying a task page illustrated in accordance with an example arrangement.

FIG. 5 is a schematic diagram of displaying a task page illustrated in accordance with an example arrangement.

FIG. 6 is a schematic diagram of displaying a task page illustrated in accordance with an example arrangement.

FIG. 7 is a schematic diagram of displaying a task page illustrated in accordance with an example arrangement.

FIG. 8 is a flow chart of updating and displaying a task progress parameter illustrated in accordance with an example arrangement.

FIG. 9 is a block diagram of a task processing apparatus illustrated in accordance with an example arrangement.

FIG. 10 is a block diagram of an electronic device for task processing illustrated in accordance with an example arrangement.

### DETAILED DESCRIPTION

In order to enable a person of ordinary skill in the art to better understand the technical solutions of the present disclosure, the technical solutions in the arrangements of the present disclosure will be clearly and completely described below with reference to the accompanying drawings.

It should be noted that the terms “first,” “second,” etc. in the specification, claims and the above accompanying drawings of the present disclosure are used to distinguish similar objects, but not necessarily be used to describe a particular order or sequence. It should be understood that the terms so used are interchangeable under appropriate circumstances so that the arrangements of the disclosure described herein can be practiced in sequences other than those illustrated or described herein. The implementations described in the example arrangements below are not intended to represent all implementations consistent with this disclosure. Rather, they are merely examples of apparatus and methods consistent with some aspects of the present disclosure, as detailed in the appended claims.

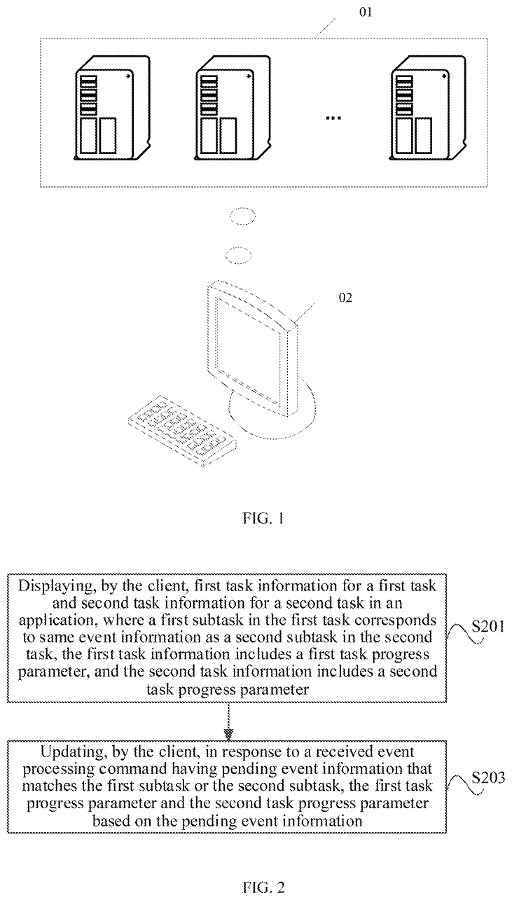

Referring to FIG. 1, FIG. 1 is a schematic diagram of an application environment for a task processing method illustrated in accordance with an example arrangement. The application environment may include servers 01 and a client 02, as shown in FIG. 1.

In an alternative arrangement, the above-mentioned client 02 may display first task information for a first task and second task information for a second task in an application. A first subtask in the first task corresponds to the same event information as a second subtask in the second task. The first task information includes a first task progress parameter, and the second task information includes a second task progress parameter. In response to an event processing command received by the client 02 having pending event information that matches the first subtask or the second subtask, the first task progress parameter and the second task progress parameter are updated according to the pending event information. The above-mentioned client may include, but is not limited to, a smartphone, desktop computer, tablet computer, laptop computer, smart speaker, digital assistant, Augmented Reality (AR)/Virtual Reality (VR) device, smart wearable device, and other types of electronic devices. It can also be software running on the above electronic device, such as applications, applets, etc. In some arrangements, the operating system running on the electronic device may include, but is not limited to, Android, IOS, Linux, windows, Unix, etc.

In some arrangements, the server 01 may be a device that sends event processing commands to the client 02. The server 01 may be a standalone physical server or a server cluster or distributed system composed of multiple physical servers, and may also be a cloud server that provides cloud services, cloud database, cloud computing, cloud functions, cloud storage, network services, cloud communications, middleware services, domain name services, security services, Content Delivery Network (CDN), big data and artificial intelligence platforms, and other basic cloud computing services.

In some arrangements, the client and server can be connected to each other via a wired link, or via a wireless link.

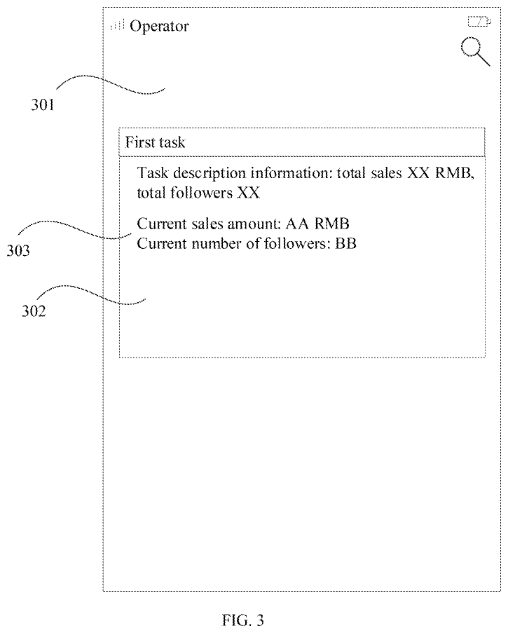

FIG. 2 is a flow chart of a task processing method illustrated in accordance with an example arrangement. The task processing method can be applied to a client and also to other node devices as shown in FIG. 2.

At S201, displaying, by the client, first task information for a first task and second task information for a second task in an application, where a first subtask in the first task corresponds to same event information as a second subtask in the second task, the first task information includes a first task progress parameter, and the second task information includes a second task progress parameter.

In the arrangements of this application, the client may display the first task information for the first task and the second task information for the second task on the application, or the client may also display the first task information for the first task and the second task information for the second task on an opened browser website.

In some arrangements, the first task may include one or more subtasks, and the second task may include one or more subtasks. For example, the first task may include a first subtask and a third subtask, and the second task may include a second subtask (e.g., there may be only one subtask included in the second task). Of course, in addition to the first and second tasks mentioned above, the application or website may also be provided with a third task, a fourth task, a fifth task, etc., where the third, fourth, and fifth tasks may also include one or more subtasks.

For the convenience of description, the first task and the second task are used as examples for description in the arrangements of the present application. It is assumed that the first task includes a first subtask (e.g., sales task) and a third subtask (e.g., gain followers task), and the second task includes one subtask, i.e., the second subtask (e.g., sales task). In some arrangements, the above-mentioned sales task or the gain followers task is only an optional implementation, and there may be other tasks, including tasks related to the length of video playback, the number of hours spent watching live broadcasts, following the anchor, the number of posts, the number of times the app was opened, the number of interactions between the host and the host's audience, etc.

In some arrangements, the first subtask in the first task and the second subtask in the second task may correspond to the same event information. For example, the event information of both the first subtask and the second subtask is sales event information, and thus the sales event information can correspond to the first subtask in the first task and the second subtask in the second task. That is, the same event information can satisfy the subtasks in both tasks.

At S203, updating, by the client, in response to a received event processing command having pending event information that matches the first subtask or the second subtask, the first task progress parameter and the second task progress parameter based on the pending event information.

Based on the above example that both the first subtask and the second subtask are sales tasks, and that the event information is sales event information to proceed to describe S203. Assuming that the pending event information included in the received event processing command is the above-mentioned sales event information, since the first subtask in the first task and the second subtask in the second task correspond to the same event information, when there is pending event information (sales event information) matching the first subtask or the second subtask in the received event processing command, the client can update the first task progress parameter and the second task progress parameter based on the pending event information.

In some arrangements, the client may display the first task information for the first task on the task page. FIG. 3 is a schematic diagram of displaying a task page illustrated in accordance with an example arrangement, which shows a task page 301, and the first task information 302 of the first task on the task page 301. The first task information 302 may include a first task progress parameter 303, and the first task progress parameter 303 may include a first sub-progress parameter corresponding to the first subtask (e.g., current sales amount: AA RMB) and a third sub-progress parameter corresponding to the third subtask (e.g., current number of followers: BB).

Taking FIG. 3 into account for description, the first task may include a first subtask and a third subtask, where the first subtask can be to reach XX RMB in total sales in the task description information in FIG. 3 and the third subtask can be that the total number of followers reaches XX in the task description information.

In the arrangements of this application, based on the first subtask and the third subtask described above, if there is first pending event information (e.g., sales event information) that matches the first subtask or the second subtask in an event processing command received by the client, the client can update the first sub-progress parameter based on the first pending event information since the first subtask and the second subtask correspond to the same event information. And/or, if there is second pending event information (e.g., gain followers event information) that matches the third subtask in the event processing command received by the client, the client can update the third sub-progress parameter based on the second pending event information.

That is, there can be pending event information corresponding to one subtask in an event processing command, or there can be pending event information corresponding to multiple sub-tasks in an event processing command.

In this way, a task may include multiple subtasks and the corresponding sub-progress parameter of each subtask may be updated according to the pending event information corresponding to each subtask, which makes the arrangements of the present application applicable to more scenarios and provides the possibility for a task to carry more information and thus improve the efficiency of event processing while increasing the flexibility of the application.

In some arrangements, the event processing command may be received from other clients, or from the server.

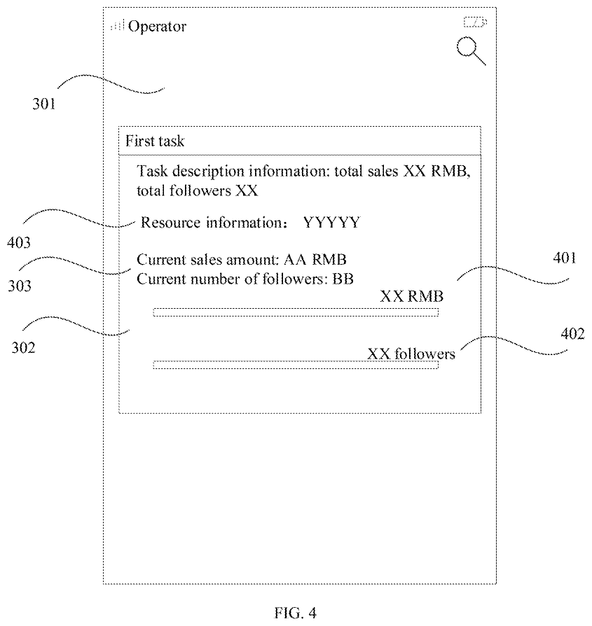

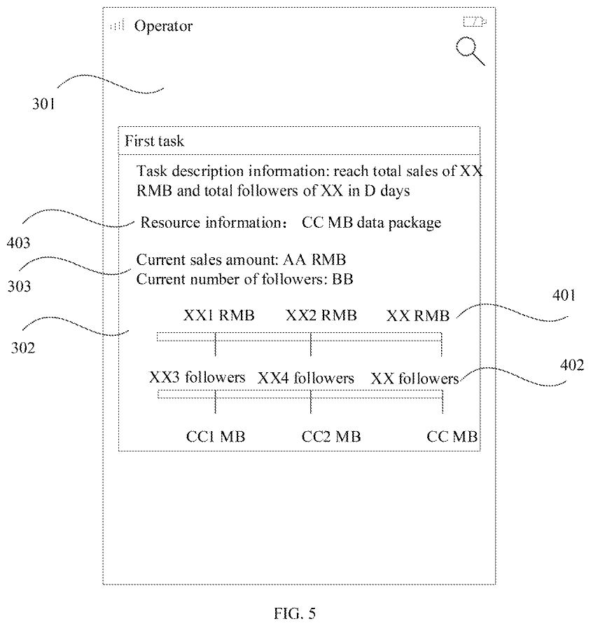

In some arrangements, the task information may include a task target parameter and resource information corresponding to the task target parameter. FIG. 4 is a schematic diagram of displaying a task page illustrated according to an example arrangement. As shown in FIG. 4, the task target parameter may also be included in addition to the task page 301 shown in FIG. 3, the first task information 302 of the first task on the task page 301, and the first task progress parameter 303 (the first sub-progress parameter corresponding to the first subtask and the third sub-progress parameter corresponding to the third subtask) included in the first task information 302.

In some arrangements, the task target parameters may be reflected by the task target parameters in the task description information (e.g., XX RMB and XX followers), and also by the first target parameter 401 corresponding to the first subtask and the third target parameter 402 corresponding to the third subtask included in the first task information 302 of the first task.

As shown in FIG. 4, the first task information 302 described above may also include resource information 403. In the arrangements of this application, if the first sub-progress parameter matches the first target parameter and the third sub-progress parameter matches the third target parameter, the client may send a resource allocation command to a resource allocation device, which is used to instruct the resource allocation device to complete the process of allocating virtual resources corresponding to the resource information to the client.

For example, if the first sub-progress parameter AA RMB matches the first target parameter XX RMB (e.g., AA is equal to XX) and the third sub-progress parameter BB followers matches the third target parameter XX followers (e.g., BB is equal to XX), the client can send the resource allocation command to the resource allocation device, and the resource allocation command is used to instruct the resource allocation device to complete the processing of allocating the virtual resources corresponding to the resource information (e.g., a CC MB data package) to the client.

In this way, only when the target parameters corresponding to the two subtasks are satisfied at the same time, the client can send the resource allocation command to the resource allocation device. The above method can motivate the client users to try to balance the resource allocation (including time, manpower) between the two subtasks, to provide better services to the audience and create a positive operating environment while trying to improve their own business.

FIG. 5 is a schematic diagram of displaying a task page illustrated in accordance with an example arrangement.

In some arrangements, as shown in FIG. 5, the first target parameter includes a plurality of first node parameters, such as the first one first node parameter “XX1 RMB,” the second one first node parameter “XX2 RMB,” and the third one first node parameter “XX RMB” in FIG. 5, where XX1 is less than XX2 and XX2 is less than XX.

The third target parameter includes a plurality of third node parameters, such as the first one third node parameter “XX3 followers,” the second one third node parameter “XX4 followers,” and the third one third parameter “XX followers” in FIG. 5, where XX3 is less than XX4 and XX4 is less than XX.

The resource information includes amounts of node resource information, such as the first piece of node resource information “CC1 MB,” the second piece of node resource information “CC2 MB” and the third piece of node resource information “CC MB,” where CC1 MB is smaller than CC2 MB and CC2 MB is smaller than CC MB.

In the arrangements of this application, if there is a target first node parameter among the plurality of first node parameters that matches the first sub-progress parameter, and there is a target third node parameter among the plurality of third node parameters that matches the third sub-progress parameter, the client may determine the target resource information from the amounts of node resource information based on the target first node parameter and the target third node parameter. Then, the client may send to the resource allocation device the resource allocation command which is used to instruct the resource allocation device to complete the processing of allocating the virtual resources corresponding to the target resource information to the client.

In an alternative arrangement, it can be shown in FIG. 5 that CC1 MB correspond to XX1 RMB and XX3 followers, CC2 MB correspond to XX2 RMB and XX4 followers, and CC MB correspond to XX RMB and XX followers, which indicates that a CC1 MB data package allocated by the resource allocation device can be obtained only when the current sales amount AA RMB matches XX1 RMB and the current number of followers matches XX3; a CC2 MB data package allocated by the resource allocation device can be obtained only when the current sales amount AA RMB matches XX2 RMB and the current number of followers matches XX4; and a CC MB package allocated by the resource allocation device can be obtained only when the current sales amount AA RMB matches XX RMB and the current number of followers matches XX.

In some arrangements, if the current sales amount AA RMB matches XX1 RMB and the current number of followers matches XX4, a CC1 MB data package allocated by the resource allocation device can be obtained. In this case, only if the two node parameters corresponding to the node resource information are reached at the same time, can the node resource information be obtained.

In some arrangements, as shown in FIG. 5, the task information 302 further includes task duration information which may be reflected in the task description information, such as “D days”.

In the arrangements of this application, if there is a target first node parameter among the plurality of first node parameters that matches the first sub-progress parameter within the time duration (e.g., “D days”) indicated by the task duration information, and there is a target third node parameter among the plurality of third node parameters that matches the third sub-progress parameter within the time duration (e.g., “D days”) indicated by the task duration information, the client may determine the target resource information from the amounts of node resource information based on the target first node parameter and the target third node parameter. Then, the client may send to the resource allocation device the resource allocation command which is used to instruct the resource allocation device to complete the processing of allocating the virtual resources corresponding to the target resource information to the client.

Therefore, in the arrangements of the present application, task progress parameters corresponding to different node parameters, enables the client users to work flexibly in order to achieve the milestones and to be able to provide better services to the audience and create a positive operating environment while improving their own business.

In the arrangements of the present disclosure, the task page may be a task page in an application on the client, or may be a task page in a website on the client. In an alternative arrangement, the client may display the first task information for the first task and the second task information for the second task on the task page of the application.

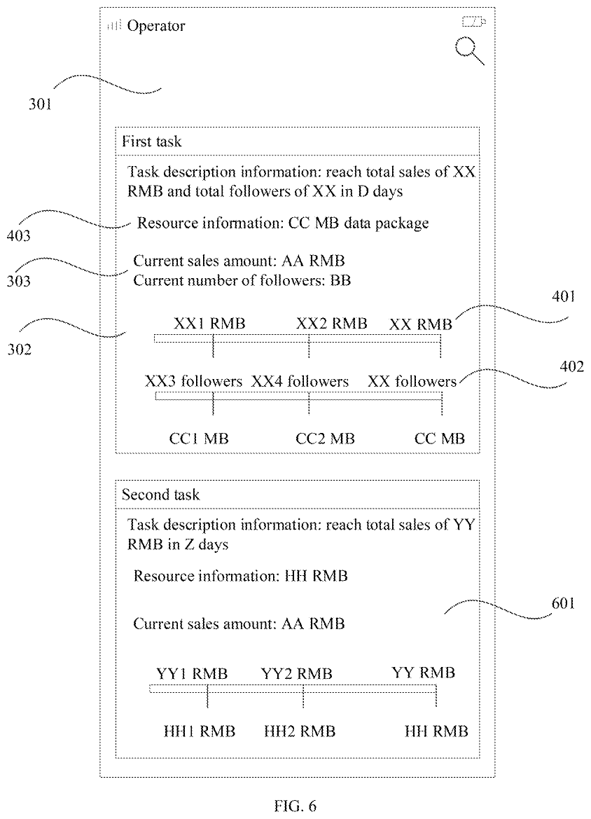

In the arrangements of this application, FIG. 6 is a schematic diagram of displaying a task page illustrated in accordance with an example arrangement. As shown in FIG. 6, the task page 301 may include, in addition to the first task information 302 for the first task, also the second task information 601 for the second task, which may include task description information, resource information, a task progress parameter, a task target parameter, etc., since the second task is a single subtask type task.

In the arrangements of this application, taking into account the size of the page occupied by the task information of the first task and the second task, both the first task and the second task can be arranged on a single page, making it more intuitive and convenient for the user to access.

In the arrangements of this application, taking into account the size of the task page, the first task and the second task may not be on the same task page, so that S201 may be represented as follows: the client displays the task information for the first task on a first task page of the application, and in response to a page switching command for the second task being detected, switches the first task page to a second task page, and displays the second task information for the second task on the second task page.

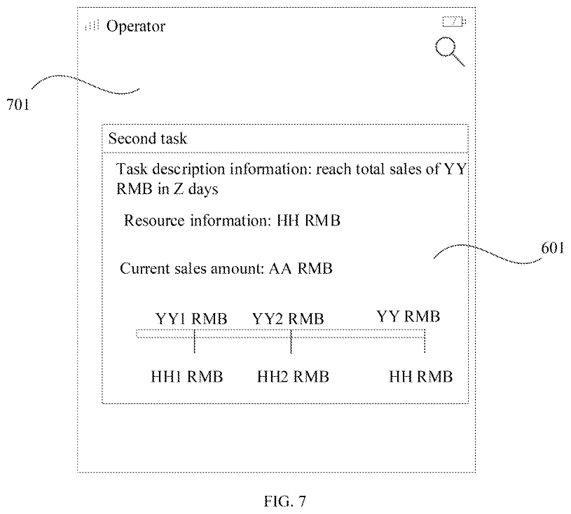

In some arrangements, the first task page includes a page skipping control. FIG. 7 is a schematic diagram of displaying a task page illustrated in accordance with an example arrangement. As shown in FIG. 7, in response to the page skipping command triggered based on the page skipping control (not shown) being detected, the client may switch the first task page (e.g., task page 301 in FIG. 5) to the second task page 701.

In some arrangements, in response to gesture information corresponding to the page switching command for the second task being detected, client may switch the first task page (e.g., task page 301 in FIG. 5) to the second task page 701. The gesture information may be predetermined gesture information on the client interface, such as “swipe left,” or “swipe right”. The gesture information may also be based on the client, such as “shake the phone,” “flip the phone” and other gestures applied to the phone.

In this way, in the arrangements of this application, taking into account the size of the page occupied by the task information of the first task and the second task, the first task and the second task can be arranged on different pages, and the pages can be switched in a certain way to provide the user with a convenient and quick operation.

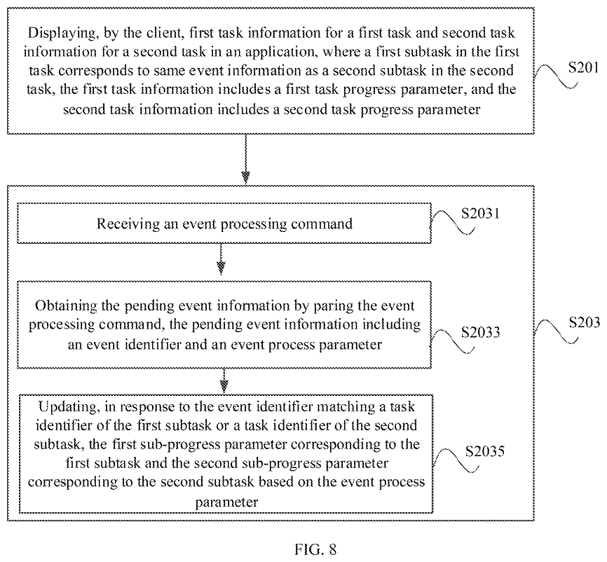

In the arrangements of this application, there is also provided an implementation for updating task progress parameters corresponding to subtasks. FIG. 8 is a flow chart of updating a task progress parameter illustrated in accordance with an example arrangement.

At S2031, receiving an event processing command.

At S2033, obtaining the pending event information by paring the event processing command, the pending event information including an event identifier and an event process parameter.

In the arrangements of this application, the event identifier can be used to indicate which event is mainly included in the pending event information, for example, the event identifier for the sales event information can be 0001, and the event identifier for the gain followers event information can be 0002. The above event identifiers are only alternative arrangements, and other feasible event identifiers may also be included.

At S2035, updating, in response to the event identifier matching a task identifier of the first subtask or a task identifier of the second subtask, the first sub-progress parameter corresponding to the first subtask and the second sub-progress parameter corresponding to the second subtask based on the event process parameter.

In some arrangements, the event process parameter may be the parameter on a current stage of the event corresponding to the sales event information. For example, when the event identifier matches the task identifier of the first subtask in the first task and the event process parameter may be determined as 500 RMB, the first sub-progress parameter is 5000 RMB and the updated first sub-progress parameter is 5500 RMB, and the second sub-progress parameter is 6000 RMB and the updated first sub-progress parameter is 6500 RMB.

In some arrangements, the first task and the second task may not be tasks started at the same point in time, for example, the first task may be the task started first and the second task planned by the planner after the first task is started, so that even if the first subtask in the first task and the second subtask in the second task correspond to the same event information, the sub-progress parameters of the first subtask and the second subtask may be inconsistent.

In view of above, the arrangements of this application, the subtasks of two tasks can be processed simultaneously by one kind of event information, which provides more application scenarios while improving the efficiency for the interaction between devices.

In the arrangements of this application, the organization information to which the first task belongs is the first organization information, and the organization information to which the second task belongs is the second organization information. In some arrangements, the first organization information and the second organization information can be the same organization information or different organization information. When they are different organization information, it means that the two tasks belong to different business lines or product lines, etc., and tasks from different departments or business or product lines are integrated in one framework to improve the interaction and communication across departments.

In summary, in the arrangements of the present application, multiple tasks (e.g. the first task and the second task) can be integrated in a single framework, multiple subtasks cam be integrated in a total task, which can improve the connection between different tasks while enriching the task application scenario, thereby improving the efficiency of task completion for the user who completes the task, thus enhancing user participation and user experience.

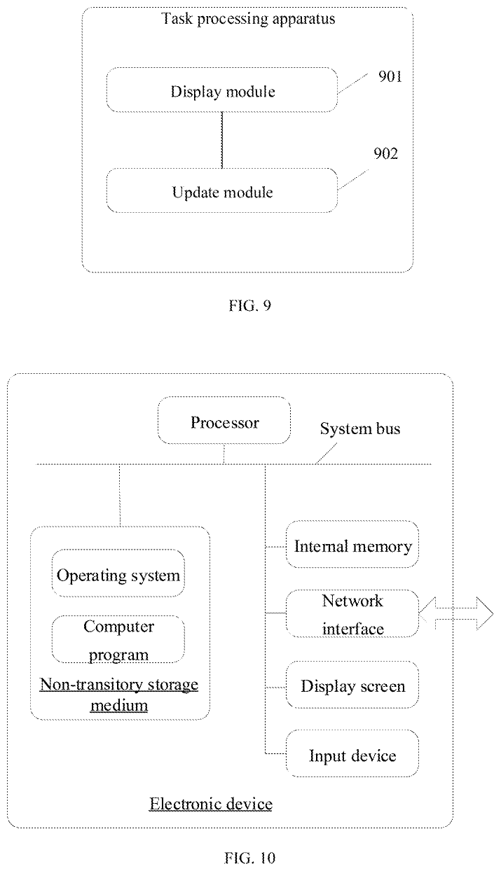

FIG. 9 is a block diagram of a task processing apparatus illustrated in accordance with an example arrangement. Referring to FIG. 9, the apparatus includes a display module 901 and an update module 902.

The display module 901 is configured to display, in an application, first task information for a first task and second task information for a second task, where a first subtask in the first task corresponds to same event information as a second subtask in the second task, the first task information includes a first task progress parameter, and the second task information includes a second task progress parameter.

The update module 902 is configured to update, in response to a received event processing command having pending event information that matches the first subtask or the second subtask, the first task progress parameter and the second task progress parameter based on the pending event information.

In some arrangements, the first task progress parameter includes a first sub-progress parameter corresponding to the first subtask and the second task progress parameter includes a second sub-progress parameter corresponding to the second subtask. The update module 902 includes a receiving sub-module configured to receive an event processing command; a parsing sub-module configured to obtain the pending event information by parsing the event processing command, the pending event information including an event identifier and an event process parameter; and an update sub-module configured to update, in response to the event identifier matching a task identifier of the first subtask or a task identifier of the second subtask, the first sub-progress parameter corresponding to the first subtask and the second sub-progress parameter corresponding to the second subtask based on the event process parameter.

In some arrangements, the above-mentioned display module 901 is configured to display, on a task page of the application, the first task information for the first task and the second task information for the second task.

In some arrangements, the above-mentioned display module 901 includes a first display module configured to display, on a first task page of the application, the first task information for the first task; a switching module configured to switch, in response to a page switching command for the second task being detected, the first task page to a second task page; and a second display module configured to display, on the second task page, the second task information for the second task.

In some arrangements, the first task page includes a page skipping control; and the above-mentioned switching module is configured to switch, in response to a page skipping command triggered based on the page skipping control being detected, the first task page to the second task page.

In some arrangements, the above-mentioned switching module is configured to switch, in response to gesture information corresponding to the page switching command for the second task being detected, the first task page to the second task page.

In some arrangements, the first task further includes a third subtask, and the first task progress parameter includes a first sub-progress parameter corresponding to the first subtask and a third sub-progress parameter corresponding to the third subtask; and the update module 902 is configured to update, in response to the received event processing command having a first pending event information that matches the first subtask or the second subtask, the first sub-progress parameter based on the first pending event information; and/or update, in response to the received event processing command having a second pending event information that matches the third subtask, the third sub-progress parameter based on the second pending event information.

In some arrangements, the first task information comprises a task target parameter and resource information corresponding to the task target parameter; and the task target parameter includes a first target parameter corresponding to the first subtask and a third target parameter corresponding to the third subtask; and the above apparatus further includes: a sending module configured to send, in response to the first sub-progress parameter matching the first target parameter and the third sub-progress parameter matching the third target parameter, a resource allocation command to a resource allocation device, the resource allocation command being configured to instruct the resource allocation device to allocate virtual resources corresponding to the resource information to the client.

In some arrangements, the first target parameter includes a plurality of first node parameters and the third target parameter includes a plurality of third node parameters; and the resource information includes amounts of node resource information; and the above sending module includes a resource information determination module configured to determine, in response to the plurality of first node parameters including a target first node parameter that matches the first sub-progress parameter and the plurality of third node parameters comprising a target third node parameter that matches the third sub-progress parameter, target resource information from the amounts of node resource information based on the target first node parameter and the target third node parameter; and a command sending module configured to send the resource allocation command to the resource allocation device, the resource allocation command being configured to instruct the resource allocation device to allocate virtual resources corresponding to the target resource information to the client.

Regarding the apparatus in the above arrangements, the specific way in which each module performs its operation has been described in detail in the arrangements concerning the method, and will not be described in detail here.

FIG. 10 is a block diagram of an electronic device 1000 for task processing illustrated in accordance with an example arrangement.

The electronic device can be a server or a terminal device, the internal structure of which can be shown in FIG. 10. The electronic device includes a processor connected via a system bus, a memory, and a network interface. The processor of the electronic device is used to provide computing and control capabilities. The memory of the electronic device includes a non-transitory storage medium and an internal memory. The non-transitory storage medium stores an operating system and a computer program. The internal memory provides an environment for operation of the operating system and the computer program in the non-transitory storage medium. The network interface of the electronic device is used to communicate with an external terminal via a network connection. The computer program is executed by the processor to implement a task processing method.

It will be understood by those skilled in the art that the structure illustrated in FIG. 10, which is only a block diagram of a portion of the structure associated with the presently disclosed solution, does not constitute a limitation of the electronic device to which the presently disclosed solution is applied, and that the specific electronic device may include more or fewer components than shown in the figure, or may be combined with certain components, or have a different arrangement of components.

In example arrangements, there is also provided an electronic device including a processor; a memory for storing instructions executable by the processor; where the processor is configured to execute the instructions to implement the task processing method as described in the arrangements of the present disclosure.

In example arrangements, there is also provided a non-transitory computer-readable storage medium that, when the instructions in the computer-readable storage medium are executed by a processor of the electronic device, enables the electronic device to perform the task processing method of arrangements of the present disclosure.

In example arrangements, there is also provided a computer program product, the computer program product including a computer program, the computer program stored in a readable storage medium, and at least one processor of the computer device reading and executing the computer program from the readable storage medium causing the computer device to perform the task processing method of arrangements of the present disclosure.

One of ordinary skill in the art can understand that achieving all or part of the processes in the methods of the above arrangements is accomplished by directing the associated hardware by means of a computer program, which may be stored in a non-transitory computer readable storage medium, which computer program, when executed, may include processes such as those of the arrangements of the methods described above. Any references to memory, storage, databases, or other media used in the arrangements provided in this application may include non-transitory and/or transitory memory. Non-transitory memory may include read-only memory (ROM), programmable ROM (PROM), electrically programmable ROM (EPROM), electrically erasable programmable ROM (EEPROM), or flash memory. Volatile memory may include random access memory (RAM) or external cache memory. By way of illustration and not limitation, RAM is available in a variety of forms, such as static RAM (SRAM), dynamic RAM (DRAM), synchronous DRAM (SDRAM), double data rate SDRAM (DDRSDRAM), enhanced SDRAM (ESDRAM), Synchlink DRAM (SLDRAM), memory bus (Rambus) direct RAM (RDRAM), direct memory bus dynamic RAM (DRDRAM), and memory bus dynamic RAM (RDRAM).

Other arrangements of the present disclosure will readily be anticipated by those skilled in the art upon consideration of the specification and practice of the arrangements disclosed herein. This application is intended to cover any variations, uses, or adaptations of the present disclosure that follow the general principles of the present disclosure and include common knowledge or techniques in the technical field not disclosed by the present disclosure. The specification and examples are to be regarded as example only, and the true scope and spirit of the disclosure being indicated by the following claims.

It should be understood that the present disclosure is not limited to the precise structures described above and illustrated in the accompanying drawings, and that various modifications and changes may be made without departing from the scope thereof. The scope of the present disclosure is limited only by the scope of the appended claims.

What is claimed is:

1. A task processing method, comprising:
displaying, by a client, first task information for a first task and second task information for a second task in an application, wherein a first subtask in the first task corresponds to same event information as a second subtask in the second task, the first task information comprises a first task progress parameter, and the second task information comprises a second task progress parameter; and
updating, by the client, in response to a received event processing command having pending event information that matches the first subtask or the second subtask, the first task progress parameter and the second task progress parameter based on the pending event information.

2. The task processing method of claim 1, wherein the first task progress parameter comprises a first sub-progress parameter corresponding to the first subtask, and the second task progress parameter comprises a second sub-progress parameter corresponding to the second subtask; and
wherein updating, by the client, in response to a received event processing command having pending event information that matches the first subtask or the second subtask, the first task progress parameter and the second task progress parameter based on the pending event information, comprises:
receiving an event processing command;
obtaining the pending event information by parsing the event processing command, the pending event information comprising an event identifier and an event process parameter; and
updating, in response to the event identifier matching a task identifier of the first subtask or a task identifier of the second subtask, the first sub-progress parameter corresponding to the first subtask and the second sub-progress parameter corresponding to the second subtask based on the event process parameter.

3. The task processing method of claim 1, wherein displaying, by the client, first task information for a first task and second task information for a second task in an application, comprises:
displaying, on a task page of the application, the first task information for the first task and the second task information for the second task.

4. The task processing method of claim 1, wherein displaying, by the client, first task information for a first task and second task information for a second task in an application, comprises:
displaying, on a first task page of the application, the first task information for the first task;
switching, in response to a page switching command for the second task being detected, the first task page to a second task page; and
displaying, on the second task page of the application, the second task information for the second task.

5. The task processing method of claim 4, wherein the first task page comprises a page skipping control; and
wherein switching, in response to a page switching command for the second task being detected, the first task page to a second task page, comprises:
switching, in response to a page skipping command being detected, the first task page to the second task page, wherein the page skipping command is triggered based on the page skipping control.

6. The task processing method of claim 4, wherein switching, in response to a page switching command for the second task being detected, the first task page to a second task page, comprises:
switching, in response to gesture information corresponding to the page switching command for the second task being detected, the first task page to the second task page.

7. The task processing method of claim 1, wherein the first task further comprises a third subtask, and the first task progress parameter comprises a first sub-progress parameter corresponding to the first subtask and a third sub-progress parameter corresponding to the third subtask; and
wherein updating, by the client, in response to a received event processing command having pending event information that matches the first subtask or the second subtask, the first task progress parameter based on the pending event information, comprises at least one of:
updating, in response to the received event processing command having a first pending event information that matches the first subtask or the second subtask, the first sub-progress parameter based on the first pending event information; and
updating, in response to the received event processing command having a second pending event information that matches the third subtask, the third sub-progress parameter based on the second pending event information.

8. The task processing method of claim 7, wherein the first task information comprises a task target parameter and resource information corresponding to the task target parameter; and the task target parameter comprises a first target parameter corresponding to the first subtask and a third target parameter corresponding to the third subtask; and
wherein the method further comprises:
sending, in response to the first sub-progress parameter matching the first target parameter and the third sub-progress parameter matching the third target parameter, a resource allocation command to a resource allocation device, the resource allocation command being configured to instruct the resource allocation device to allocate virtual resources corresponding to the resource information to the client.

9. The task processing method of claim 8, wherein the first target parameter comprises a plurality of first node parameters and the third target parameter comprises a plurality of third node parameters; and the resource information comprises amounts of node resource information; and
wherein sending, in response to the first sub-progress parameter matching the first target parameter and the third sub-progress parameter matching the third target parameter, a resource allocation command to a resource allocation device, the resource allocation command being configured to instruct the resource allocation device to allocate virtual resources corresponding to the resource information to the client, comprises:
determining, in response to the plurality of first node parameters comprising a target first node parameter that matches the first sub-progress parameter and the plurality of third node parameters comprising a target third node parameter that matches the third sub-progress parameter, target resource information from the amounts of node resource information based on the target first node parameter and the target third node parameter; and
sending the resource allocation command to the resource allocation device, the resource allocation command being configured to instruct the resource allocation device to allocate virtual resources corresponding to the target resource information to the client.

10. An electronic device, comprising:
a processor; and
a memory for storing instructions executable by the processor;
wherein the processor is configured to execute the instructions to:
display first task information for a first task and second task information for a second task in an application, wherein a first subtask in the first task corresponds to same event information as a second subtask in the second task, the first task information comprises a first task progress parameter, and the second task information comprises a second task progress parameter; and
update, in response to a received event processing command having pending event information that matches the first subtask or the second subtask, the first task progress parameter and the second task progress parameter based on the pending event information.

11. The electronic device of claim 10, wherein the first task progress parameter comprises a first sub-progress parameter corresponding to the first subtask, and the second task progress parameter comprises a second sub-progress parameter corresponding to the second subtask; and
wherein the processor is configured to update the first task progress parameter and the second task progress parameter based on the pending event information by:
receiving an event processing command;
obtaining the pending event information by parsing the event processing command, the pending event information comprising an event identifier and an event process parameter; and
updating, in response to the event identifier matching a task identifier of the first subtask or a task identifier of the second subtask, the first sub-progress parameter corresponding to the first subtask and the second sub-progress parameter corresponding to the second subtask based on the event process parameter.

12. The electronic device of claim 10, wherein the processor is further configured to:
display, on a task page of the application, the first task information for the first task and the second task information for the second task.

13. The electronic device of claim 10, wherein the processor is further configured to:
display, on a first task page of the application, the first task information for the first task;
switch, in response to a page switching command for the second task being detected, the first task page to a second task page; and
display, on the second task page of the application, the second task information for the second task.

14. The electronic device of claim 13, wherein the first task page comprises a page skipping control; and
wherein the processor is configured to switch the first task page to a second task page by:
switching, in response to a page skipping command being detected, the first task page to the second task page, wherein the page skipping command is triggered based on the page skipping control.

15. The electronic device of claim 13, wherein the processor is configured to switch the first task page to a second task page by:
switching, in response to gesture information corresponding to the page switching command for the second task being detected, the first task page to the second task page.

16. The electronic device of claim 10, wherein the first task further comprises a third subtask, and the first task progress parameter comprises a first sub-progress parameter corresponding to the first subtask and a third sub-progress parameter corresponding to the third subtask; and
wherein the processor is configured to update the first task progress parameter based on the pending event information by at least one of:
updating, in response to the received event processing command having a first pending event information that matches the first subtask or the second subtask, the first sub-progress parameter based on the first pending event information; and
updating, in response to the received event processing command having a second pending event information that matches the third subtask, the third sub-progress parameter based on the second pending event information.

17. The electronic device of claim 16, wherein the first task information comprises a task target parameter and resource information corresponding to the task target parameter; and the task target parameter comprises a first target parameter corresponding to the first subtask and a third target parameter corresponding to the third subtask; and
wherein the processor is further configured to:
send, in response to the first sub-progress parameter matching the first target parameter and the third sub-progress parameter matching the third target parameter, a resource allocation command to a resource allocation device, the resource allocation command being configured to instruct the resource allocation device to allocate virtual resources corresponding to the resource information to the client.

18. The electronic device of claim 17, wherein the first target parameter comprises a plurality of first node parameters and the third target parameter comprises a plurality of third node parameters; and the resource information comprises amounts of node resource information; and
wherein the processor is configured to send a resource allocation command to a resource allocation device by:
determining, in response to the plurality of first node parameters comprising a target first node parameter that matches the first sub-progress parameter and the plurality of third node parameters comprising a target third node parameter that matches the third sub-progress parameter, target resource information from the amounts of node resource information based on the target first node parameter and the target third node parameter; and
sending the resource allocation command to the resource allocation device, the resource allocation command being configured to instruct the resource allocation device to allocate virtual resources corresponding to the target resource information to the client.

19. A non-transitory computer readable storage medium, wherein instructions in the computer readable storage medium, when executed by a processor of an electronic device, enable the electronic device to perform a task processing method comprising:
displaying first task information for a first task and second task information for a second task in an application, wherein a first subtask in the first task corresponds to same event information as a second subtask in the second task, the first task information comprises a first task progress parameter, and the second task information comprises a second task progress parameter; and
updating in response to a received event processing command having pending event information that matches the first subtask or the second subtask, the first task progress parameter and the second task progress parameter based on the pending event information.

20. A computer program product, comprising a computer program stored in a readable storage medium, wherein at least one processor of a computer device reads and executes the computer program from the readable storage medium, causing the computer device to perform the task processing method of claim 1.
